(19) United States
(12) Patent Application Publication
(10) Pub. No.: US 2026/0110335 A1
(43) Pub. Date: Apr. 23, 2026

(54) BEARING DEVICE WITH INTEGRATED ELECTRICAL INSULATION, IN PARTICULAR FOR AN ELECTRIC MOTOR OR MACHINE

(71) Applicant: AKTIEBOLAGET SKF, GOTEBORG (SE)

(72) Inventors: Benoit ARNAULT, Saint-Cyr-sur-Loire (FR); Thomas PERROTIN, Saint Roch (FR); Anthony SIMONIN, Tours (FR); Emmanuel BENEVISE, Monts (FR)

(21) Appl. No.: 19/358,623

(22) Filed: Oct. 15, 2025

(30) Foreign Application Priority Data
Oct. 22, 2024 (FR) FR2411471

(51) Int. Cl. F16C 35/077; F16C 43/04

(52) U.S. Cl. CPC F16C 35/077; F16C 43/04; F16C 2380/26

(57) ABSTRACT

A bearing device includes a bearing having first and second rings, a bushing having first and second annular parts each having an axially extending cylindrical portion and radially inwardly extending annular collar and an electrically insulating lining overmolded between and connecting the first and second parts of the bushing and the second ring. The radial collar of the first part of the bushing extends radially beyond a surface of the second ring and includes a plurality of circumferentially spaced through-holes. The insulating lining includes a plurality of blind holes, each extending axially inward from one of the through-holes, and bottoms of the blind holes are axially spaced from the second ring.

This application claims priority to French patent application no. FR2411471 filed on October 22, 2024, the contents of which are fully incorporated herein by reference.

### TECHNOLOGICAL FIELD

The present disclosure relates to the field of bearings used, in particular, in electric motors, electric machines and associated equipment.

### BACKGROUND

In an electric motor or an electric machine, at least one rolling bearing is mounted between the housing of the electric motor or the electric machine and the rotating shaft in order to support this shaft. During operation when the shaft is in rotation, a difference in electrical potential can occur between the shaft and the housing of the electric motor or the electric machine, which generates an electric current between the inner ring of the rolling bearing which is fixed to the shaft and the outer ring which is fixed to the housing. The electric current passing through the components of the rolling bearing can damage these components, in particular the rolling elements and the raceways formed on the internal and outer rings. The electrical discharges can also generate vibrations.

In order to remedy these drawbacks, it is known to replace the rolling elements of the bearing, which are produced from the same steel as that of the internal and outer rings, by rolling elements which are manufactured from ceramic. Generally this is referred to as a hybrid rolling bearing. However, such a hybrid rolling bearing is relatively costly.

In order to remedy the aforementioned drawbacks, it is also known to provide the outer ring of the rolling bearing with an insulating sleeve which is provided with a bushing and an insulating lining which is produced from electrically insulating material and which is radially interposed between the outer ring and the bushing.

In order to implement the fixing of the insulating lining on the outer ring and on the bushing without an additional element or particular machining on the outer ring, it is possible to overmold the insulating lining. However, with such a solution, a detachment relative to the insulating lining and the bushing can arise during operation.

### SUMMARY

The present disclosure thus aims to remedy the aforementioned drawbacks by proposing a bearing device of simple and economical design. The disclosure relates to a bearing device comprising a bearing having a first ring and a second ring which are configured to rotate relative to one another.

The device also comprises at least one insulating sleeve which is mounted on the second ring of the bearing. The insulating sleeve includes a bushing and an insulating lining which is interposed radially between the second ring of the bearing and the bushing. The insulating lining is produced from electrically insulating material. The bushing has an external surface and an internal surface, opposing the external surface, which delimit the radial thickness of the bushing.

The second ring has an external surface and an internal surface, opposing the external surface, which delimit the radial thickness of the second ring and first and second front faces delimiting the axial length of the second ring.

The insulating lining is overmolded at least on one of the external and internal surfaces of the second ring of the bearing and at least on one of the external and internal surfaces of the bushing.

According to a general feature, the bushing is produced in at least two separate first and second parts, each comprising an axial portion and a radial collar extending radially inward from the axial portion. According to a further general feature, the axial portions of the first and second parts jointly at least partially delimit the surface of the bushing on which the insulating lining is overmolded.

According to a further general feature, at least the radial collar of the first part of the bushing extends radially beyond the external surface or internal surface of the second ring on which the insulating lining is overmolded, and is provided with a plurality of through-holes which are spaced apart relative to one another in the circumferential direction.

According to a further general feature, the insulating lining is also overmolded on an internal face of the radial collar of each of the first and second parts of the bushing and overmolded at least partially on the first and second front faces of the second ring.

According to a further general feature, the insulating lining comprises a group of blind holes, each extending axially inside one of the through-holes of the radial collar of the first part of the bushing and remaining axially at a distance from the first front face of the second ring.

The production of the two parts of the bushing with radial collars makes it possible to achieve an effective fixing to the insulating lining. The risk of relative displacements between the insulating lining and the bushing in the axial direction is avoided, in particular in the event of temperature variations.

"Axial direction" is understood to mean the direction parallel to the axis of the bearing device.

Moreover, relative to a one-piece production of the bushing provided with collars, the production thereof in at least two separate parts facilitates the placing of the second ring inside the mold provided for overmolding the insulating lining.

Moreover, taking account of the dimensioning of the radial collar of the first part of the bushing, the part of the insulating lining which is located axially between the second ring and this radial collar is not subjected to shear stresses when significant axial loads are applied to the device mounted inside the housing of the motor or the electric machine associated with this collar which bears against a shoulder of the housing. More specifically, in this case, compressive stresses are applied to this part of the insulating lining. This increases the reliability of the device.

Each blind hole of the insulating lining corresponds to the footprint of the injector used when overmolding the insulating lining during the manufacture of the bearing device. The injection of material via the through-holes of the radial collar of the first part of the bushing makes it possible to increase the radial dimension of this radial collar and the bearing surface with the housing of the motor or the associated electric machine. This also makes it possible to reduce the volume of material of the insulating lining which is more expensive than the material of the bushing.

According to one particular design, the insulating lining covers the bore of each hole of the plurality of through-holes of the radial collar of the first part of the bushing. Alternatively, the insulating lining could cover only the bore of some of the holes of the plurality of through-holes.

Preferably, the radial collar of the second part of the bushing extends radially beyond the external surface or internal surface of the second ring on which the insulating lining is overmolded. Alternatively, it is possible to provide that the radial collar of the second part of the bushing remains radially offset from the external or internal surface of the second ring on which the insulating lining is overmolded.

Advantageously, the radial collar of the second part of the bushing is provided with a plurality of through-holes which are spaced apart relative to one another in the circumferential direction. In this case, the insulating lining can comprise a group of through-holes, each extending axially inside one of the through-holes and leading into the second front face of the second ring.

Each through-hole of the insulating lining corresponds to the positioning of a pin permitting the centering of the second part of the bushing and the transmission of closing forces of the mold used during the overmolding of the insulating lining.

The positioning of the pins via the through-holes of the radial collar of the second part of the bushing makes it possible to increase the radial dimension of this radial collar and the bearing surface with the housing of the motor or the associated electric machine. Once again, this makes it possible to reduce the volume of material of the insulating lining.

According to one particular design, the insulating lining covers the bore of each hole of the plurality of through-holes of the radial collar of the second part of the bushing. Alternatively, the insulating lining could cover only the bore of some of the holes of the plurality of through-holes of the radial collar of the second part of the bushing.

According to one particular design, the insulating lining can comprise, between two through-holes of the insulating lining which are successive in the circumferential direction, at least one stud extending inside one of the through-holes of the radial collar of the second part of the bushing. Alternatively, the distribution of the studs can be different. In a further variant, it is possible that the insulating lining does not have a stud if a centering pin is provided to be housed in each through-hole of the radial collar of the second part of the bushing.

In one embodiment, the first and second parts of the bushing are symmetrical relative to a radial median plane of the device. This makes it possible to reduce the cost of manufacturing the device.

According to one particular design, the axial portions of the first and second parts of the bushing are axially in contact with one another and jointly delimit the entirety of the surface of the bushing on which the insulating lining is overmolded.

According to a further design, the axial portions of the first and second parts of the bushing are axially spaced apart from one another. In this case, the bushing can also comprise an additional ring interposed axially between the axial portions of the first and second parts and jointly delimiting, with the axial portions of the first and second parts of the bushing, the surface of the bushing on which the insulating lining is overmolded.

According to one particular design, the surface of the bushing is provided with at least one groove extending in the circumferential direction, an engagement rib of the insulating lining of complementary shape extending therein. Thus the axial engagement of the insulating lining with the bushing is increased.

"Circumferential direction" is understood to mean the direction which is perpendicular both to the axial direction and to a radius of the bearing device, in other words tangent to a circle of which the center is on the axis of the bearing device.

Each axial portion of the first and second parts of the bushing can have at least one groove extending in the circumferential direction, an engagement rib of the insulating lining of complementary shape extending therein.

If the insulating lining is produced from synthetic material or elastomeric material, it enables the device to be made insensitive to temperature variations.

In one particular embodiment, the first and second parts of the bushing are produced from metallic material. The bushing can thus be easily machined to a predetermined radial tolerance.

The first and second parts of the bushing can be obtained from a sheet metal blank by cutting, stamping and rolling.

In one embodiment, the insulating lining covers the entirety of the surface of the bushing. In this case, the insulating lining covers the surface of the bushing entirely in the axial direction and in the circumferential direction.

According to a first design, the bushing delimits the external surface of the device. In this case, the second ring is the outer ring of the bearing.

According to a second alternative design, the bushing delimits the internal surface of the device. In this case, the second ring is the inner ring of the bearing.

In one particular embodiment, the bearing comprises at least one row of rolling elements which are arranged between the raceways of the first and second rings. The rolling elements can be produced from metallic material.

The disclosure further relates to an electric motor comprising a housing, a shaft and at least one bearing device as defined above and radially mounted between the housing and the shaft.

The disclosure further relates to a method for manufacturing a bearing device as defined above, comprising: a step of mounting one of the first and second parts of the bushing at the bottom of a manufacturing mold, a step of placing the second ring inside the manufacturing mold, a step of mounting the other of the first and second parts of the bushing inside the manufacturing mold, a step of placing injectors inside the through-holes of the radial collar of the first part of the bushing, the injectors remaining axially at a distance from the first front face of the second ring, a step of overmolding the insulating lining by means of the injectors and a step of assembling with the first ring of the bearing of the assembly formed by the second ring, the first and second parts of the bushing and the insulating lining.

The method can also comprise, before the step of overmolding, a step of placing centering studs inside the through-holes of the radial collar of the second part of the bushing, the studs axially bearing against the second front face of the second ring.

### BRIEF DESCRIPTION OF THE DRAWINGS

The present disclosure will be understood more clearly by studying the detailed description of an embodiment provided by way of non-limiting example and illustrated by the accompanying drawings, in which:

FIG. 1 is a front elevational view of a bearing device according to an exemplary embodiment of the disclosure.

FIG. 2 is a partial view in section along the axis II-II of FIG. 1.

FIG. 3 is a partial view in section along the axis III-III of FIG. 1.

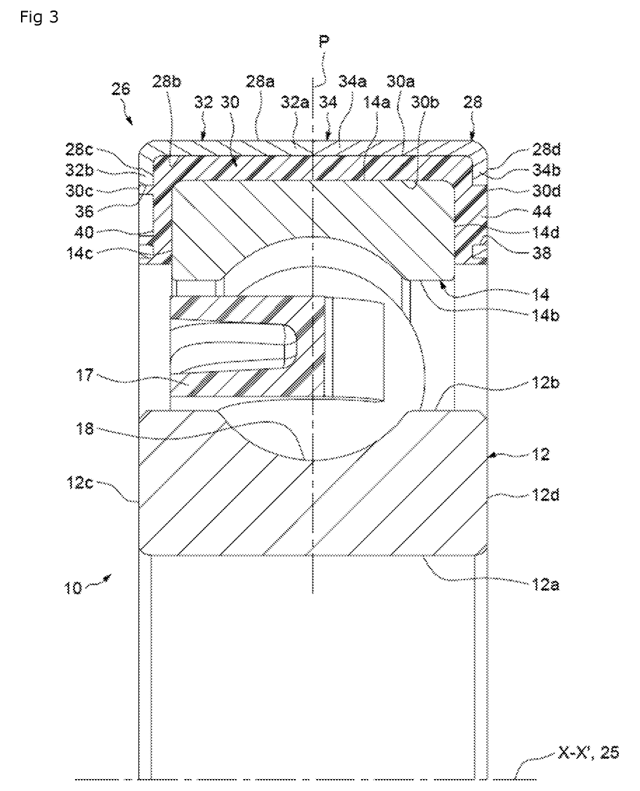

FIG. 4 is a partial exploded perspective view of the bearing device of FIG. 1 in which an insulating lining of the device is omitted for illustration purposes.

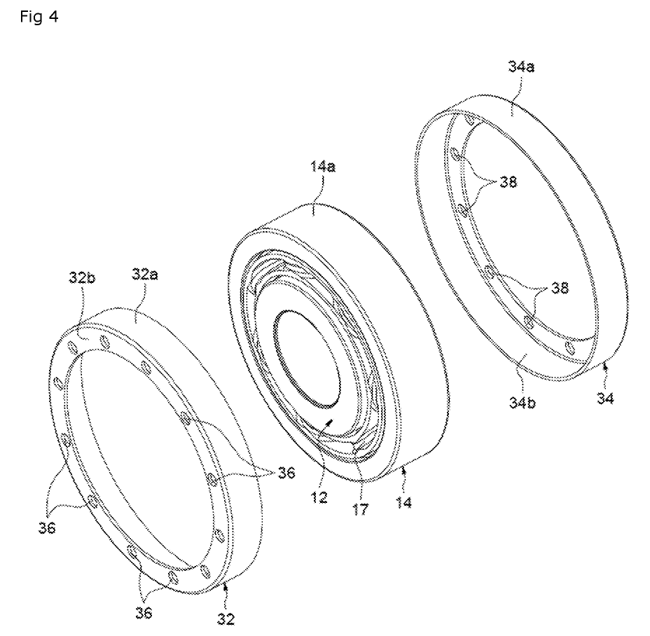

FIG. 5 is a flow chart illustrating a method for manufacturing the bearing device of FIG. 1 according to an embodiment of the disclosure.

### DETAILED DESCRIPTION

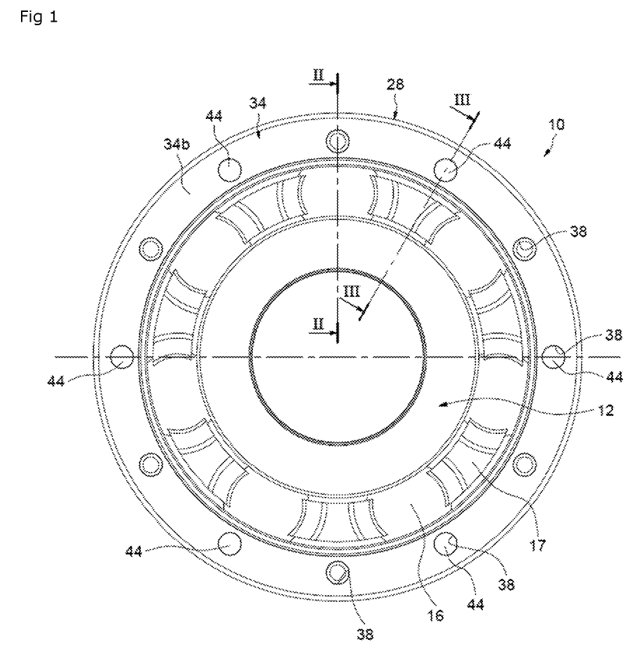

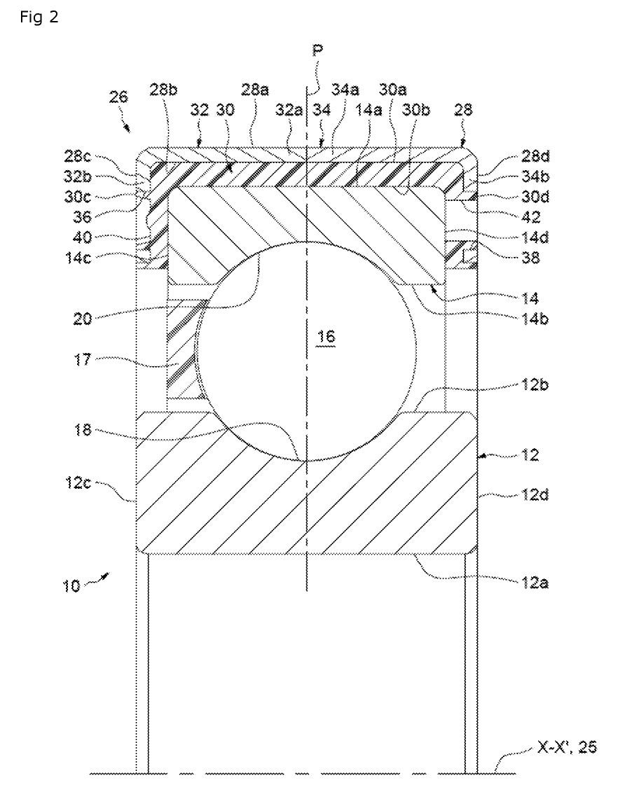

The bearing device illustrated in FIGS. 1 and 2 comprises a bearing 10 which has a first ring 12 and a second ring 14 which are configured to rotate relative to one another around the axis X – X' of the bearing. In the illustrated exemplary embodiment, the first ring 12 is the inner ring of the bearing and the second ring 14 is the outer ring.

The bearing device is designed so as not to conduct electric currents. The bearing device has integrated electrical insulation.

The inner 12 and outer 14 rings of the bearing are concentric and extend axially along the axis X – X' of the bearing. The inner 12 and outer 14 rings are produced from steel. The rings are of the solid type.

In the illustrated exemplary embodiment, the bearing 10 also comprises a row of rolling elements 16, in this case balls, interposed radially between the inner 12 and outer 14 rings. The rolling elements 16 are produced from steel. The bearing 10 also comprises a cage 17 for maintaining a uniform circumferential spacing of the rolling elements 16. The bearing 10 can also be provided with sealing gaskets or sealing flanges.

The inner ring 12 comprises a cylindrical bore 12a, a cylindrical axial external surface 12b radially opposing the bore and two opposing radial front faces 12c, 12d axially delimiting the bore and the external surface. The bore 12a and the external surface 12b delimit the radial thickness of the inner ring 12. The bore 12a forms the internal surface of the inner ring. The first and second front faces 12c, 12d delimit the axial length of the inner ring 12. The inner ring 12 further comprises an internal raceway 18 for the rolling elements 16, which is formed on the external surface 12b. The raceway 18 is radially oriented toward the outside.

The outer ring 14 comprises a cylindrical axial external surface 14a, a cylindrical bore 14b radially opposing the external surface 14a and opposing first and second radial front faces 14c, 14d axially delimiting the bore and the external surface 14a. The external surface 14a and the bore 14b delimit the radial thickness of the outer ring 14. The first and second faces 14c, 14d delimit the axial length of the outer ring 14. The outer ring 14 further comprises an external raceway 20 for the rolling elements 16, which is formed on the bore 14b. The raceway 20 is radially oriented toward the inside.

The bearing device also comprises an electrical insulating sleeve 26 which is mounted on the outer ring 14. The insulating sleeve 26 is mounted on the external surface 14a of the outer ring 14. The insulating sleeve 26 is fixed to the outer ring 14. The insulating sleeve 26 comprises a bushing 28 and an insulating lining 30 interposed radially between the outer ring 14 and the bushing 28. The insulating lining 30 is overmolded on the outer ring 14 and on the bushing 28.

The bushing 28 is of annular shape. The bushing 28 comprises separate first and second parts 32, 34. These two separate parts 32, 34 form half-flanges which in this case axially bear against one another. In the illustrated exemplary embodiment, the parts 32, 34 of the bushing are identical and symmetrical relative to a radial median plane P of the device in order to reduce manufacturing costs. The radial median plane P in this case passes through the center of the rolling elements 16. Alternatively, it is naturally possible to provide non-symmetrical parts 32, 34. In a further variant, it could be possible for the bushing 28 to have more than two parts. Preferably, the parts 32, 34 of the bushing 28 are produced from steel. The parts 32, 34 can advantageously be obtained from a sheet metal blank, by cutting, stamping and rolling. Alternatively, the parts 32, 34 can advantageously be obtained from a tube or from forged and/or rolled blanks, or even from sintering and stamping.

Each part 32, 34 of the bushing comprises a cylindrical axial portion 32a, 34a and an annular radial collar 32b, 34b extending radially inward from the cylindrical axial portion. The cylindrical axial portions 32a, 34a bear axially against one another. The radial collar 32b, 34b extend from the ends of the axial portions 32a, 34a which are located axially on the external side of the device. In the illustrated exemplary embodiment, the radial collars 32b, 34b are annular.

The bushing 28 comprises a cylindrical axial external surface 28a and a cylindrical bore 28b radially opposing the external surface 28a and of which the axis 25 is coaxial with the axis X - X'. The bore 28b forms the internal surface of the bushing 28. The bore 28b is oriented radially toward the inside, i.e. on the side of the outer ring 14 and the insulating lining 30. The axial portions 32a, 34a of the parts of the bushing jointly delimit the external surface 28a. In a similar manner, the axial portions 32a, 34a of the parts jointly delimit the bore 28b. The external surface 28a and the bore 28b delimit the radial thickness of the bushing 28. The external surface 28a of the bushing forms the external surface of the bearing device 10. In other words, the external surface 28a defines the external diameter of the bearing device 10.

The radial collars 32b, 34b of the parts of the bushing extend radially inward beyond the external surface 14a of the outer ring, i.e. radially protruding toward the inside relative to the external surface 14a. In other words, the free ends of the radial collars 32b, 34b are offset radially inward relative to the external surface 14a of the outer ring. The radial collars 32b, 34b extend up to the vicinity of the bore 14b of the outer ring, remaining radially retracted from the bore 14b. The radial collars 32b, 34b remain axially at a distance from the outer ring 14.

Each radial collar 32b, 34b of the part 32, 34 of the bushing is provided with a plurality of through-holes 36, 38 which are spaced apart relative to one another in the circumferential direction, in this case in a uniform manner. Alternatively, the spacing of the holes 36, 38 could be non-uniform.

The holes 36, 38 are identical to one another in this case. Alternatively, the holes 36, 38 may not be identical. In the illustrated exemplary embodiment, the holes 36, 38 are circular. Alternatively, the holes 36, 38 could have a different shape, for example polygonal, such as rectangular or square, oval etc.

As indicated above, the holes 36, 38 are through-holes. The holes 36, 38 axially pass through the thickness of the associated radial collar 32b, 34b of the part 32 of the bushing. The holes 36, 38 lead into the internal face and into the external face of the associated collar 32b, 34b. The internal face and the external face axially opposing the internal face of each radial collar 32b, 34b delimit the axial thickness of the collar. For each radial collar 32b, 34b, the internal face is oriented axially toward the inside of the device and the external face is oriented axially toward the outside of the device.

In the illustrated exemplary embodiment, the holes 36 of the radial collar 32b of the part 32 of the bushing are axially aligned with the holes 38 of the radial collar 34b of the part 34. Alternatively, the holes 36 could be offset at an angle to the holes 38.

The bushing 28 also comprises two opposing radially extending front faces 28c, 28d axially delimiting the external surface 28a. The front faces 28c, 28d delimit the axial length of the bushing. The front face 28c is delimited by the radial collar 32b and the front face 28d is delimited by the radial collar 34b. More specifically, the front face 28c is delimited by the external face of the radial collar 32b and the front face 28d is delimited by the external face of the radial collar 34b.

The front faces 14c, 28c of the outer ring and the bushing are located axially on a first side relative to the radial median plane P of the device, and the front faces 14d, 28d of the outer ring and the bushing are located axially on a second side, relative to the radial median plane P, which opposes the first side.

The front face 14c of the outer ring is offset axially inward relative to the front face 28c of the bushing. The front face 14d of the outer ring is offset axially inward relative to the front face 28d of the bushing. In other words, the front faces 14c, 14d of the outer ring are axially retracted relative to the front faces 28c, 28d of the bushing. The axial dimension of the outer ring 14 is less than the axial dimension of the bushing 28.

The front face 14c of the outer ring is offset axially inward relative to the front face 12c of the inner ring. The front face 14d of the outer ring is offset axially inward relative to the front face 12d of the inner ring.

The insulating lining 30 is produced from electrically insulating material. The insulating lining 30 can be produced, for example, from synthetic material, such as a PEEK or a PA46, or even produced from elastomeric material, for example from rubber.

The insulating lining 30 is radially interposed between the external surface 14a of the outer ring and the bore 28b of the bushing. The insulating lining 30 covers the external surface 14a of the outer ring. In this case, the insulating lining 30 entirely covers the external surface 14a of the outer ring, when considering the axial and circumferential directions. The insulating lining 30 also covers the front faces 14c, 14d of the outer ring.

The insulating lining 30 also covers the bore 28b of the bushing. In this case, the insulating lining 30 also entirely covers the bore 28b, when considering the axial and circumferential directions. The insulating lining 30 covers the bore of the axial portion 32a, 34a of each part 32, 34 of the bushing. The insulating lining 30 also covers the internal face of the radial collar 32b, 34b of each part 32, 34 of the bushing. The insulating lining 30 also covers the free end of the radial collar 32b, 34b of each part 32, 34 of the bushing. The insulating lining 30 also covers the bore of the through-holes 36, 38 of the radial collars 32b, 34b of the parts 32, 34 of the bushing.

The insulating lining 30 is of annular shape. The insulating lining 30 extends axially. The insulating lining 30 comprises a cylindrical axial external surface 30a, a cylindrical bore 30b radially opposing the external surface 30a and opposing first and second radially extending front faces 30c, 30d axially delimiting the bore and the external surface. The radial front faces 30c, 30d axially delimit the insulating lining 30. The external surface 30a and the bore 30b delimit the radial thickness of the insulating lining 30. The external surface 30a is in radial contact with the bore 28b of the bushing. The bore 30b is in radial contact with the external surface 14a of the outer ring and with the front faces 14c, 14d of the outer ring.

The insulating lining 30 includes a group of blind holes 40 which each extend axially inside one of the through-holes 36 of the radial collar 32b of the part 32 of the bushing. Each blind hole 40 extends axially from the front face 30c in the direction of the outer ring 14, remaining axially at a distance from the front face 14c. In other words, each blind hole 40 has a bottom which is oriented axially outward and which is offset axially outward relative to the front face 14c.

Each blind hole 40 corresponds to the positioning of an injector (not shown) permitting the overmolding of the insulating lining 30 during the manufacture of the bearing device. The shape of the blind hole 40 corresponds to the footprint of the associated injector. The blind holes 40 are in this case identical to one another. Alternatively, the blind holes 40 may not be identical when the injectors of the electrically insulating material of the insulating lining 30 have a different shape.

As indicated above, in the illustrated exemplary embodiment, the insulating lining 30 covers the bore of the through-holes 36 of the radial collar 32b of the part 32 of the bushing. Thus a bead of material is present radially between each blind hole 40 and the associated through-hole 36 of the radial collar 32b. Alternatively, it could be possible not to have such a bead of material in the event of the injector being centered relative to the bore of the through-hole 36 during the overmolding of the insulating lining 30.

In the illustrated exemplary embodiment, the number of blind holes 40 is equal to the number of through-holes 36 of the radial collar 32b of the part 32 of the bushing. Alternatively, as a function of the number of injectors, the number of blind bores 40 could be less than that of the number of through-holes 36.

The insulating lining 30 also comprises a group of through-holes 42 which each extend axially inside one of the through-holes 38 of the radial collar 34b of the part 34 of the bushing. Each through-hole 42 extends axially from the front face 30d in the direction of the outer ring 14 and leads into the front face 14d.

Each through-hole 42 corresponds to the positioning of a pin (not shown) permitting the centering of the part 34 of the bushing and the transmission of closing forces of the mold used during the manufacture of the bearing device. The shape of the through-hole 42 corresponds to the footprint of the associated pin. The through-holes 42 are identical to one another in this case. Alternatively, the through-holes 42 may not be identical when the pins have a different shape.

As indicated above, in the illustrated exemplary embodiment, the insulating lining 30 covers the bore of the through-holes 38 of the radial collar 34b of the part 34 of the bushing. Thus a bead of material is present radially between each through-hole 42 and the associated through-hole 38 of the radial collar 34b. Alternatively, it could be possible not to have such a bead of material in the event of the pin being centered relative to the bore of the through-hole 38 during the overmolding of the insulating lining 30.

In the illustrated exemplary embodiment, the insulating lining 30 comprises, between two successive through-holes 42 in the circumferential direction, a stud 44 extending inside the through-holes 38 of the radial collar 34b of the part 34 of the bushing. The number of through-holes 42 is thus less than the number of through-holes 38. Alternatively, the number of through-holes 42 could be equal to the number of through-holes 38.

In the illustrated exemplary embodiment, the front face 14c of the outer ring is offset axially inward relative to the front face 30c of the insulating lining. The front face 14d of the outer ring is offset axially toward the inside relative to the front face 30d of the insulating lining.

In the illustrated exemplary embodiment, the faces 30c, 28c and 30d, 28d of the insulating lining and of the bushing are respectively coplanar. Alternatively, it is possible to provide different arrangements. For example, the bushing 28 could extend so as to protrude axially from the insulating lining 30 relative to the faces 30c and 30d, or remain axially retracted from these faces.

In the illustrated exemplary embodiment, the faces 12c, 28c and 12d, 28d of the inner ring and of the bushing are respectively coplanar. Alternatively, it is possible to provide different arrangements. For example, the bushing 28 could extend so as to protrude axially relative to the faces 12c and 12d of the inner ring, or remain axially retracted from these faces.

In order to manufacture the bearing device, the disclosure proceeds in the following manner.

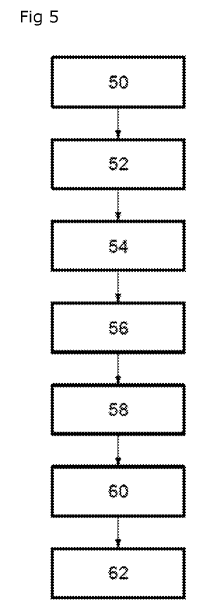

In a first step 50, illustrated schematically in FIG. 5, the second part 34 of the bushing is mounted inside the mold which is provided for the overmolding of the insulating lining 30. The studs of the mold permit the centering of the second part 34. In a second successive step 52, the outer ring 14 is placed inside the mold. Then in a third step 54, the first part 32 of the bushing is mounted inside the mold axially bearing against the first part 32. In this position, mounted inside the mold, the first part 32 and the second part 34 of the bushing are radially at a distance from the outer ring 14.

Then in a fourth successive step 56, the insulating lining 30 is overmolded by means of injectors of the mold positioned inside through-holes 36 of the radial collar 32b of the part 32 of the bushing. The insulating lining 30 is overmolded both on the outer ring 14 and on the first and second parts 32, 34 of the bushing 28. In a fifth successive step 58, the unitary assembly, formed by the outer ring 14, by the first and second parts 32, 34, the bushing 28 and by the insulating lining 30, is removed from the mold.

Then in a sixth successive step 60, the front faces 28c, 28d of the bushing are ground. Taking account of the presence of the collars 32b and 34b of the bushing, the grinding operation is carried out principally thereon and not on the insulating lining 30. During this step, the external surface 28a of the bushing and the raceway 20 of the outer ring can also be ground. Then in a seventh step 62, the unitary assembly, formed by the outer ring 14, the first and second parts 32, 34, the bushing 28 and the insulating lining 30, is assembled with the row of rolling elements 16, the cage 17 and the inner ring 12.

In the illustrated exemplary embodiments, the first ring 12 of the bearing is the inner ring and the second ring 14, on which the insulating lining 30 is overmolded, is the outer ring.

Alternatively, it is possible to provide a reverse arrangement in which the second ring 14, on which the insulating lining 30 is overmolded, is the inner ring. In this case, the insulating sleeve is located in the bore 12a of the inner ring. The insulating lining is thus interposed radially between the bore 12a of the inner ring and the external surface of the bushing. The insulating lining is overmolded on the inner ring and at least on the external surface of the bushing. The bore of the bushing delimits the bore of the bearing device.

In the exemplary embodiments described, the bearing of the device is provided with a single row of rolling elements. In a variant, the bearing can be provided with a plurality of rows of rolling elements. Moreover, the rolling bearing can comprise different types of rolling elements from balls, for example rollers. In a further variant, the bearing can be a plain bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electrically insulated bearing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the first ring and the second ring each having a first cylindrical surface and a second cylindrical surface radially spaced from the first cylindrical surface and a first annular side surface and a second annular side surface axially spaced from the first annular side surface and a maximum axial width,
a bushing having a first cylindrical surface and a second cylindrical surface and a radial thickness from the first cylindrical surface of the bushing to the second cylindrical surface of the bushing and a first annular side surface and a second axial side surface axially spaced from the first annular side surface of the bushing and a maximum axial width, and
an electrically insulating insert overmolded between and connecting the bushing and the second cylindrical surface of the second ring,
wherein the bushing is formed from separate first and second parts meeting at a circumferential joint, the first part of the bushing and the second part of the bushing each comprising a cylindrical axially extending portion and a radially inwardly extending annular collar, the axially extending portions of the first and second parts of the bushing jointly delimiting a surface of the bushing on which the insulating lining is overmolded,
wherein the radial collar of the first part of the bushing extends radially beyond the external surface of the second ring and includes a plurality of first through-holes spaced apart from each other in a circumferential direction,
wherein the insulating lining is overmolded on an internal face of the radial collar of each of the first and second parts of the bushing and is overmolded at least partially on the first and second front faces and the second cylindrical surface of the second ring, and
wherein the insulating lining includes a plurality of first blind holes, each extending axially inward from a respective one of the first through-holes of the radial collar of the first part of the bushing, bottoms of the first blind holes being axially spaced from the second ring.

2. The device according to claim 1,
wherein the insulating lining extends into each of the plurality of first through-holes of the radial collar of the first part of the bushing.

3. The device according to claim 2,
wherein the radial collar of the second part of the bushing extends radially beyond the external surface of the second ring.

4. The device according to claim 3,
wherein the radial collar of the second part of the bushing includes a plurality of second through-holes which are spaced apart relative to one another in the circumferential direction, and
wherein the insulating lining comprising a group of second blind holes, each extending axially inward from a respective one of the second through-holes, bottoms of the second blind holes being spaced from the second ring.

5. The device according to claim 4,
wherein the insulating lining extends into each of the plurality of second through-holes of the radial collar of the second part of the bushing.

6. The device according to claim 5,
wherein the insulating lining comprises, between two through-holes of the radial collar of the second part of the bushing, at least one stud extending inside one of the through-holes of the radial collar of the second part of the bushing.

7. The device according to claim 6,
wherein the first part of the bushing and the second part of the bushing are symmetrical relative to a radial median plane of the bearing.

8. The device according to claim 7,
wherein the axial portions of the first and second parts of the bushing jointly delimit an entirety of a surface of the bushing on which the insulating lining is overmolded.

9. A method comprising:
providing a first ring and a second ring configured to rotate relative to each other about a central axis, the first ring and the second ring each having a first cylindrical surface and a second cylindrical surface radially spaced from the first cylindrical surface and a first annular side surface and a second annular side surface axially spaced from the first annular side surface and a maximum axial width, and
a bushing formed from separate first and second parts configured to meet at a circumferential joint, the first part of the bushing and the second part of the bushing each comprising a cylindrical axial portion and a radially inwardly extending annular collar, the radial collar of the first part of the bushing including a plurality of through-holes spaced apart from each other in a circumferential direction,
the method comprising:
placing the first part of the bushing in a manufacturing mold,
placing the second ring in the manufacturing mold,
placing the second part of the bushing in the manufacturing mold,
inserting injectors into the first through-holes of the radial collar of the first part of the bushing, the injectors remaining axially spaced from the first annular front face of the second ring,
injecting an electrically insulating material into the manufacturing mold to connect the first part of the bushing and the second part of the bushing to the second ring, and
after the injecting, assembling the first ring of the bearing and the second ring of the bearing to form a bearing having the electrically insulating material overmolded between the bushing and the second ring.

10. An electric motor comprising:
a housing,
a shaft, and
a bearing device according to claim 1 supporting the shaft in the housing.
